(19) United States
(12) Patent Application Publication
(10) Pub. No.: US 2012/0029812 A1
(43) Pub. Date: Feb. 2, 2012

(54) METHOD AND SYSTEM FOR AUTOMATICALLY PLANNING AND SCHEDULING A REMOTE SENSING SATELLITE MISSION

(75) Inventors: Hani Abdulaziz Altwaijry, Riyadh (SA); Hussam Abdulrahman Alfaleh, Riyadh (SA); Aqil Mohammad Mustafa Azmi, Riyadh (SA)

(73) Assignee: King Abdul Aziz City for Science and Technology, Riyadh (SA)

(21) Appl. No.: 12/846,016

(22) Filed: Jul. 29, 2010

(51) Int. Cl. G05D 1/10; G01C 21/00

(52) U.S. Cl. 701/226

(57) ABSTRACT

The present invention provides method and system for automatically planning and scheduling a remote sensing satellite mission. A swath coverage of a remote sensing satellite at a specified time interval is determined from a ground station. Thereafter, a set of points-of-interest lying within the swath coverage of the remote sensing satellite at the specified time interval is identified. The method further includes associating a goodness factor to each point-of-interest of the set of points-of-interest based on a satellite mission requirement. An artificial intelligence searching algorithm is utilized to select a sub-set of points-of-interest from the set of points-of-interest based on a satellite resource constraint and a corresponding goodness factor associated with each point-of-interest. Finally, the method schedules the remote sensing satellite to capture at least one image for each point-of-interest of the sub-set of points-of-interest.

### FIELD OF THE INVENTION

The invention generally relates planning a remote sensing satellite mission. More specifically, to a method and system for automatically planning and scheduling a remote sensing satellite mission for capturing images.

### BACKGROUND OF THE INVENTION

Mission planning for a remote sensing satellite involves allocating imaging resources and time slots for scheduling the remote sensing satellite to capture images of various points-of-interest on Earth. Typically, a remote sensing satellite mission needs to be planned at a ground station in advance by a satellite mission team. Thereafter, the mission plan is transmitted to the remote sensing satellite orbiting around the Earth.

In order to plan the mission, the satellite mission team determines the path that will be taken by the remote sensing satellite in the future and selects the points-of-interest that lie within a swath coverage of the remote sensing satellite. The process of selecting the points-of-interest is a cumbersome task which requires huge investment of resources and time when it is done manually. The operator needs to analyze the ground track manually and examine a large number of points-of-interest; thereby consuming a large amount of time. Also, as the entire operation is done manually, it becomes very difficult to select a best possible point-of-interest. As a result, the satellite mission team is overburdened when the number of missions that need to be planned and the number of points-of-interest that need to be selected are large. Further, in case of manual processing, there are chances of overlooking important points-of-interest when various spatial and temporal constraints are taken into account inappropriately. This may lead to errors in the mission planning.

Additionally, various other constraints such as a weather constraint, a constraint associated with memory of the remote sensing satellite, a constraint associated with power supply of the remote sensing satellite, are required to be taken into account prior to selecting the points-of-interest. However, it becomes impractical and time consuming to consider each of the constraints while scheduling the remote sensing satellite for the points-of-interest lying within the swath coverage of the remote sensing satellite based on future positions of the remote sensing satellite.

Therefore, there is a need for a method and a system that automates the planning of a remote sensing satellite mission and ensures precision and quality in the selection of the points-of-interest.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram showing an environment (that is exemplary) in which various embodiments of the invention can function.

FIG. 2 illustrates a system for automatically planning and scheduling a remote sensing satellite mission from a ground station at a specified interval in accordance with an embodiment of the invention.

FIG. 3 illustrates a flowchart of a method for automatically planning and scheduling a remote sensing satellite mission from a ground station at a specified time interval in accordance with an embodiment of the invention.

FIG. 4 illustrates a flowchart of a method for determining the swath coverage of the remote sensing satellite on Earth at the specified time interval in accordance with an embodiment of the invention.

FIG. 5 illustrates a flowchart of a method for identifying the set of points-of-interest lying within the swath coverage of the remote sensing satellite at the specified time interval.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and system for automatic planning and scheduling of a remote sensing satellite mission. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a method and system for automatically planning and scheduling a remote sensing satellite mission. The method includes determining a swath coverage of a remote sensing satellite on Earth at a specified time interval from a ground station. In response to determining the swath coverage a set of points-of-interest lying within the swath coverage of the remote sensing satellite at the specified time interval is identified. The method further includes associating a goodness factor to each point-of-interest in the set of points-of-interest based on a satellite mission requirement. Thereafter, an artificial intelligence searching algorithm is employed to select a sub-set of points-of-interest from the set of points-of-interest based on a satellite resource constraint and the corresponding goodness factor associated with each point-of-interest. Subsequently, the remote sensing satellite is scheduled to capture at least one image for each point-of-interest of the sub-set of points-of-interest.

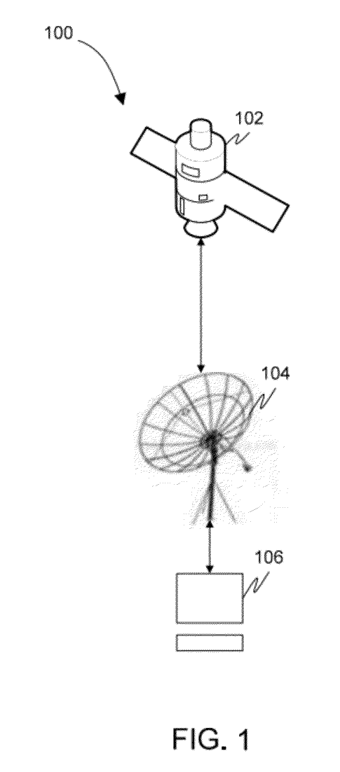

FIG. 1 is a block diagram of an environment 100 (that is exemplary) in which various embodiment of the invention may function. Environment 100 includes a remote sensing satellite 102, a transceiver 104, and a ground control centre 106. Although FIG. 1 depicts a single remote sensing satellite interacting with a single transceiver, a person of ordinary skill in the art would appreciate that a plurality of remote sensing satellites may interact with a plurality of transceivers in a multitude manner. For example, one or more remote sensing satellites may interact with a single transceiver. Similarly, one or more transceivers may interact with a single remote sensing satellite. Further, it will be evident to a person skilled in the art that the invention is not limited to the context of remote sensing satellites as described herein, and other image acquisition devices such as airplanes that take aerial image shots and unmanned aerial vehicles may also suffice.

In an embodiment of the invention, transceiver 104 and ground control centre 106 together constitute a ground station for sending and receiving data from remote sensing satellite 102. Ground control centre 106 is usually operated by a human being and the data that is sent to remote sensing satellite 102 primarily includes commands and instructions for executing a given operation. Ground control centre 106 creates the commands and instructions and forwards them to transceiver 104. After receiving the commands and instructions, transceiver 104 forwards them to remote sensing satellite 102. In an embodiment, a local processor (not shown in the figure) adaptively coupled to remote sensing satellite 102 may be utilized for translating the commands and instructions to one or more satellite commands that may be executed by remote sensing satellite 102. The commands and instructions guide remote sensing satellite 102 to perform various operations related to a remote sensing satellite mission. Further, ground control centre 106 may also send commands and instructions for operations involving maintenance of remote sensing satellite 102.

Remote sensing satellite 102 performs operations pertaining to the remote sensing satellite mission based on the commands and instructions received by it. The remote sensing satellite mission may include information about various geographical areas, phenomena, and structures for which images need to be captured by remote sensing satellite 102. For example, a satellite mission may involve capturing images of all major cities in United States. After receiving the commands and instructions from transceiver 104, remote sensing satellite 102 executes the commands and instructions in the local processor associated with remote sensing satellite 102. Thereafter, results of the execution of the commands and instructions are sent back to transceiver 104. Data that is received from remote sensing satellite 102 at transceiver 104 may include telemetry information corresponding to satellite maintenance and images captured by remote sensing satellite 102.

After receiving the data from remote sensing satellite 102, transceiver 104 forwards the data to ground control centre 106. The data is processed by ground control center 106 and is stored in a database (not shown in the figure). It will be evident to a person skilled in the art that the invention is not limited to the exact context as provided herein and several permutations and combinations of the various elements described in the exemplary embodiment are possible.

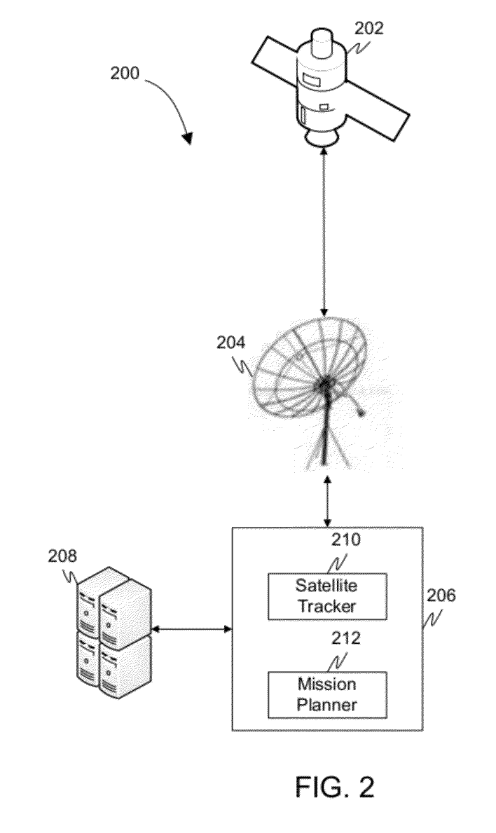

FIG. 2 illustrates a system 200 for automatically planning and scheduling a remote sensing satellite mission from a ground station at a specified time interval in accordance with an embodiment of the invention. System 200 includes a remote sensing satellite 202, a transceiver 204, a ground control centre 206, and a spatial database 208. In an embodiment, transceiver 204 and ground control centre 206 together constitute the ground station.

Remote sensing satellite 202 interacts with ground control centre 206 through transceiver 204 for sending and receiving data. Ground control centre 206 includes a satellite tracker 210, which is adaptively coupled to a mission planner 212. Mission planner 212 performs mission planning operations for remote sensing satellite 202. A Mission planning operation corresponds to the process of scheduling image capturing times for remote sensing satellite 202. Satellite tracker 210 determines a swath coverage of remote sensing satellite 202 at various points in time associated with flight of remote sensing satellite 202. The swath coverage corresponds to an area imaged on surface of the Earth as seen by imaging sensors located on remote sensing satellite 202. Thus, the swath coverage provides an area on the Earth for which remote sensing satellite 202 can acquire images. The swath coverage usually ranges in width from tens to hundreds of kilometers.

In order to determine the swath coverage of remote sensing satellite 202 at the specified time interval, satellite tracker 210 performs one or more mathematical operations on orbital elements associated with remote sensing satellite 202 to determine orbital state vectors of remote sensing satellite 202 in a coordinate system. The orbital state vectors define position and velocity of remote sensing satellite 202. The orbital state vectors are used by satellite tracker 210 to calculate position of remote sensing satellite 202 in geodetic coordinates. For example, satellite tracker 210 may use the orbital state vectors to determine position of remote sensing satellite in terms of latitude and longitude. Further, satellite tracker 210 may also use the orbital state vectors to determine a point in time when remote sensing satellite would pass over a particular position on Earth. In an embodiment, satellite tracker 210 may transform a coordinate system associated with the orbital state vectors into another coordinate system before determining the swath coverage.

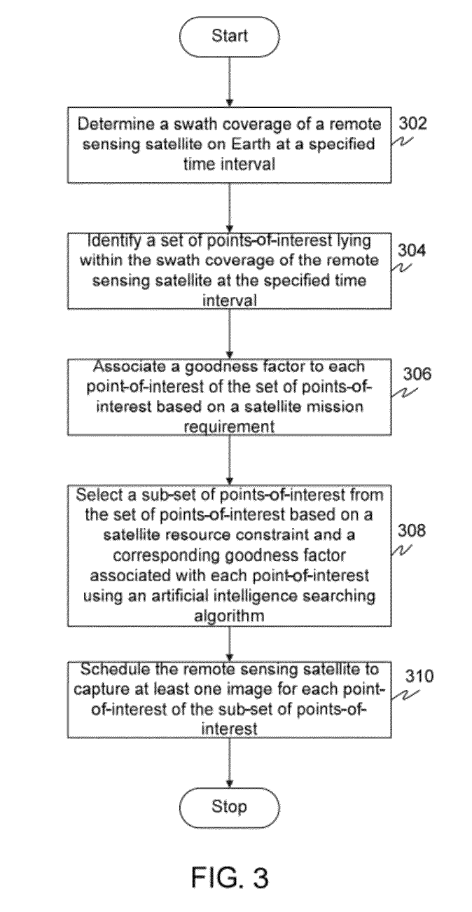

Thereafter, satellite tracker 210 performs one or more operations to determine the swath coverage of remote sensing satellite 202 at the specified time interval. For example, satellite tracker 210 may determine position of remote sensing satellite 202 at time t₀, and then at time t₁. The position information at time t₀ and t₁ is processed to determine the swath coverage of remote sensing satellite 202 for time interval t₀ to t₁. Thus, satellite tracker 210 is configured to track motion of remote sensing satellite 202 and predict places for which images can be captured by remote sensing satellite 202. This is further explained in conjunction with FIG. 3.

Once, the swath coverage of remote sensing satellite 202 at the specified time interval is determined, mission planner 212 identifies a set of points-of-interest lying within the swath coverage of remote sensing satellite 202 at the specified time interval. The set of points-of-interest may correspond to one or more of a geographical feature, a geographical phenomenon, a geographical structure, a person, and an object. For example, a point-of-interest may correspond to one or more of a river, a volcano, a building, a city, and a country. It will be evident to a person skilled in the art that the invention is not restricted to any particular context of the points-of-interest as described herein, and may correspond to any other objects present on Earth or in space.

In order to identify the set of points-of-interest lying within the swath coverage, mission planner 212 uses information of the swath coverage as an input to query spatial database 208. For example, mission planner 212 may use four points enclosing a polygon as an input to query spatial database 208 for identifying the set of points-of-interest lying within the four points. This is further explained in conjunction with FIG. 3. Spatial database 208 (or, as it is sometimes known, Geographic Information System) stores information about various points-of-interest on Earth. The information about the various points-of-interest may be stored in spatial database 208 by storing parameters such as “location” and “type” associated with each point-of-interest. For example, a point-of-interest may correspond to one or more of a type such as a point, a line, and a polygon. Further, spatial database 208 may be associated with an optimized index for improving the performance of spatial database 208. Thus, spatial database 208 is optimized for storage and retrieval of the various points-of-interest.

In an embodiment, mission planner 212 may segment the specified time interval to identify the set of points-of-interest lying within the swath coverage at the specified time interval. In order to obtain a segmented representation of the specified time interval, mission planner 212 divides the specified time interval into one or more discrete portions. Each discrete portion of the one or more discrete portions corresponds to a time fragment. For example, a 30 minutes time interval may be segmented into a series of one second non-continuous time fragments. As a result of dividing the specified time interval, computational load on mission planner 212 is reduced thereby enabling mission planner 212 to handle the identification of the set of points-of-interest more efficiently.

In order to identify the set of points-of-interest, mission planner 212 scans each time fragment for the set of points-of-interest. Mission planner 212 may use four points that enclose a polygon within a time fragment as an input to query spatial database 208 to scan the time fragment. The four points may correspond to geodetic longitude and latitude. For example, a sample query as shown below may be used for identifying the set of points-of-interest within the time fragment.

SELECT (...) FROM geonames WHERE (....) AND St_contains (GeomFromText (‘POLYGON ((point 1, point 2, point 4, point 3, point 1))’, SRID), Location);

In an embodiment, mission planner 212 may use OpenGIS standard as the format for running the query in spatial database 208. For example, an exemplary query in accordance with OpenGIS standard format as shown below may be utilized for querying spatial database 208 for the set of points-of-interest.

“SELECT (....) FROM database WHERE (...) AND St_contains (GeomFromText (‘POLYGON ((point 1, point 2, point 4, point 3, point 1))’, SRID), LOCATION);”

The execution of the query in spatial database 208 results in identification of the set of points-of-interest lying within the swath coverage of remote sensing satellite 202. After identifying the set of points-of-interest, mission planner 212 associates a goodness factor with each point-of-interest of the set of points-of-interest based on a satellite mission requirement. The goodness factor associated with each point-of-interest indicates a utility level of the point-of-interest with respect to the remote sensing satellite mission. The utility level describes the usefulness of the point-of-interest for the remote sensing satellite mission. For example, while performing a remote sensing satellite mission, the goodness factor may be utilized to determine if a first point-of-interest is better than a second point-of-interest.

Mission planner 212 associates the goodness factor to each point-of-interest of the set of points-of-interest by performing one or more fitness calculation steps. The one or more fitness calculation steps process each point-of-interest of the set of points-of-interest to determine the utility level of each point-of-interest of the set of points-of-interest based on the satellite mission requirement. For example, if a mission of a remote sensing satellite is to capture images of all the major cities in the world, then cities that are capital of a country would correspond to cities having a higher utility level with respect to the remote sensing satellite mission.

The satellite mission requirements that are considered for execution of the one or more fitness calculation steps for associating the goodness factor may correspond to one or more of a user defined criteria and a user defined constraint. The user defined criteria may be modeled as a point-of-interest “type”, and a “weightage” associated with the point-of-interest such that the user defined criteria may be used in a mathematical formula by the one or more fitness calculation steps for associating the goodness factor. For example, in a remote sensing satellite mission, a user defined criteria may correspond to assigning more weightage to big cities as compared to small towns on Earth for capturing images. Here, the user defined criteria may be expressed by giving points-of-interest of type “capital of a country” more weight than points-of-interest of type “small town”. Thus, the user defined criteria is dependent on a goal of the remote sensing satellite mission. The user defined constraint may correspond to a constraint that a human operator may consider during execution of the remote sensing satellite mission. For example, some capital cities may be more important than other capital cities for the remote sensing satellite mission.

After associating the goodness factor to each point-of-interest of the set of points-of-interest, mission planner 212 prioritizes each point-of-interest of the set of points-of-interest to obtain a sub-set of points-of-interest. The sub-set of points-of-interest corresponds to those points-of-interest for which one or more images may be captured successfully by remote sensing satellite 202. In an embodiment, the prioritization may be done only for certain points-of-interest. For example, the prioritization may be done only for such points-of-interest that are important with respect to the remote sensing satellite mission. Further, when remote sensing satellite 202 has limited memory space and limited power supply, the goodness factor ensures that one or more images of a maximum number of the set of points-of-interest are captured by prioritizing each point-of-interest of the set of points-of-interest.

The sub-set of points-of-interest is selected based on satellite resource constraints and the corresponding goodness factor associated with each point-of-interest using an artificial intelligence searching algorithm. The satellite resource constraint may include one or more of a weather constraint, a constraint associated with memory of the remote sensing satellite 202, and a constraint associated with power supply of remote sensing satellite 202. The weather constraint includes constraint associated with weather status at the specified time interval over the swath coverage of remote sensing satellite 202 at the specified time interval. For example, when weather over a particular portion of the swath coverage of remote sensing satellite 202 at the specified time interval is expected to deteriorate, the artificial intelligence searching algorithm may not select the points-of-interest present in that particular portion of the swath coverage of remote sensing satellite 202.

Memory constraint associated with remote sensing satellite 202 includes information about available free memory present in remote sensing satellite 202. Thus, when available free memory present in remote sensing satellite 202 is not enough to accommodate each of the points-of-interest present in the swath coverage of remote sensing satellite 202, the artificial intelligence searching algorithm will select a smaller sub-set of points-of-interest present in the swath coverage of remote sensing satellite 202.

Similar to the memory constraint, the constraint associated with the power supply of remote sensing satellite 202 provides information about remaining available power supply of remote sensing satellite 202. The remaining available power supply may be used for predicting how many images may be captured successfully by remote sensing satellite 202. Thus, if the remaining available power supply of remote sensing satellite 202 is not enough to capture images of all points-of-interest lying within the swath coverage of remote sensing satellite 202, the artificial intelligence searching algorithm may not select all the points-of-interest present in the swath coverage of remote sensing satellite 202. Further, in accordance with an embodiment, mission planner 212 may also consider power required for setting-up remote sensing satellite 202 to a “ready” state for capturing the images of the sub-set of points-of-interest. Thus, the power supply constraint provides information concerning the available remaining power of remote sensing satellite 202.

Based on the satellite resource constraint, the artificial intelligence searching algorithm selects the sub-set of points-of-interest. The sub-set of points-of-interest represent points-of-interest that best fit the remote sensing satellite mission based on the satellite resource constraint. The artificial intelligence searching algorithm may include one or more of a local search algorithm, and a greedy search algorithm.

While selecting the sub-set of points-of-interest using the local search algorithm, one or more points-of-interest of the set of points-of-interest may be randomly selected based on a time required for capturing one or more images of the one or more points-of-interest. Thereafter, a least fitting point-of-interest of the one or more points-of-interest may be selected and replaced with another randomly selected point-of-interest of the one or more points-of-interest. The least fitting point-of-interest is replaced with another randomly selected point-of-interest in order to find a better fitting image. This operation may be performed iteratively until a fairly good result is obtained.

While selecting the sub-set of points-of-interest using the greedy search algorithm, each point-of-interest of the set of points-of-interest is prioritized based on the satellite resource constraints and the goodness factor. Thereafter, each point-of-interest of the set of points-of-interest is selected based on best available resources of remote sensing satellite 202 in the order of their goodness factor without considering how a selection of each point-of-interest affects selection of other points-of-interest. Subsequently, the greedy search algorithm determines whether any un-selected points-of-interest may be selected based on the satellite resource constraint. If additional points-of-interest satisfy the satellite resource constraint, then they are selected based on the order of their goodness factor.

In addition to the satellite resource constraint, the artificial intelligence searching algorithm utilizes the goodness factor associated with each point-of-interest of the set of points-of-interest while selecting the sub-set of points-of-interest. Thus, the artificial intelligence searching algorithm gives more importance to a point-of-interest having a high goodness factor when compared to points-of-interest having a low goodness factor. It will be evident to a person skilled in the art that the invention is not restricted to any particular satellite resource constraint as described herein; and may utilize various other constraints while selecting the sub-set of points-of-interest from the set of points-of-interest.

After selecting the sub-set of points-of-interest from the set of points-of-interest, mission planner 212 schedules remote sensing satellite 202 to capture one or more images for each point-of-interest of the sub-set of points-of-interest at the specified time interval. In order to schedule remote sensing satellite 202, mission planner 212 sends a scheduling command to remote sensing satellite 202 through transceiver 204. The scheduling command instructs remote sensing satellite 202 to capture the one or more images of each point-of-interest of the sub-set of points-of-interest when remote sensing satellite 202 is positioned above the swath coverage at the specified time interval. For example, at the specified time interval, when remote sensing satellite 202 is positioned above the swath coverage, it captures one or more images of each point-of-interest of the sub-set of points-of-interest automatically.

FIG. 3 illustrates a flowchart of a method for automatically planning and scheduling a remote sensing satellite mission from a ground station at a specified time interval in accordance with an embodiment of the invention. At step 302, satellite tracker 210 determines a swath coverage of remote sensing satellite 202 at a specified time interval. The specified time interval may correspond to one or more of a current time, and a specified time interval in the future. The swath coverage corresponds to an area imaged on surface of the Earth as seen by imaging sensors located on remote sensing satellite 202. This has already been explained in conjunction with FIG. 2.

In order to determine the swath coverage, satellite tracker performs one or more mathematical operations on orbital elements associated with remote sensing satellite 202 to determine orbital state vectors of remote sensing satellite 202 in a coordinate system. The orbital state vectors define position and velocity of remote sensing satellite 202. The orbital state vectors are used by satellite tracker 210 to calculate position of remote sensing satellite 202 in geodetic coordinates. For example, satellite tracker 210 may use the orbital state vectors to determine position of remote sensing satellite in terms of latitude and longitude. It will be evident to a person skilled in the art that the invention is not restricted to a particular coordinate system and any other coordinate system may also be employed for representing the position of remote sensing satellite 202. For example, the position of remote sensing satellite 202 may also be represented using one or more of Earth-Centered Inertial (ECI) coordinates, and Earth-centered, Earth-fixed (ECEF) coordinates. In an embodiment, satellite tracker 210 may employ a coordinate system converter for converting between different coordinate systems. For example, the coordinate system converter may be used for converting the ECI coordinates to ECEF coordinates.

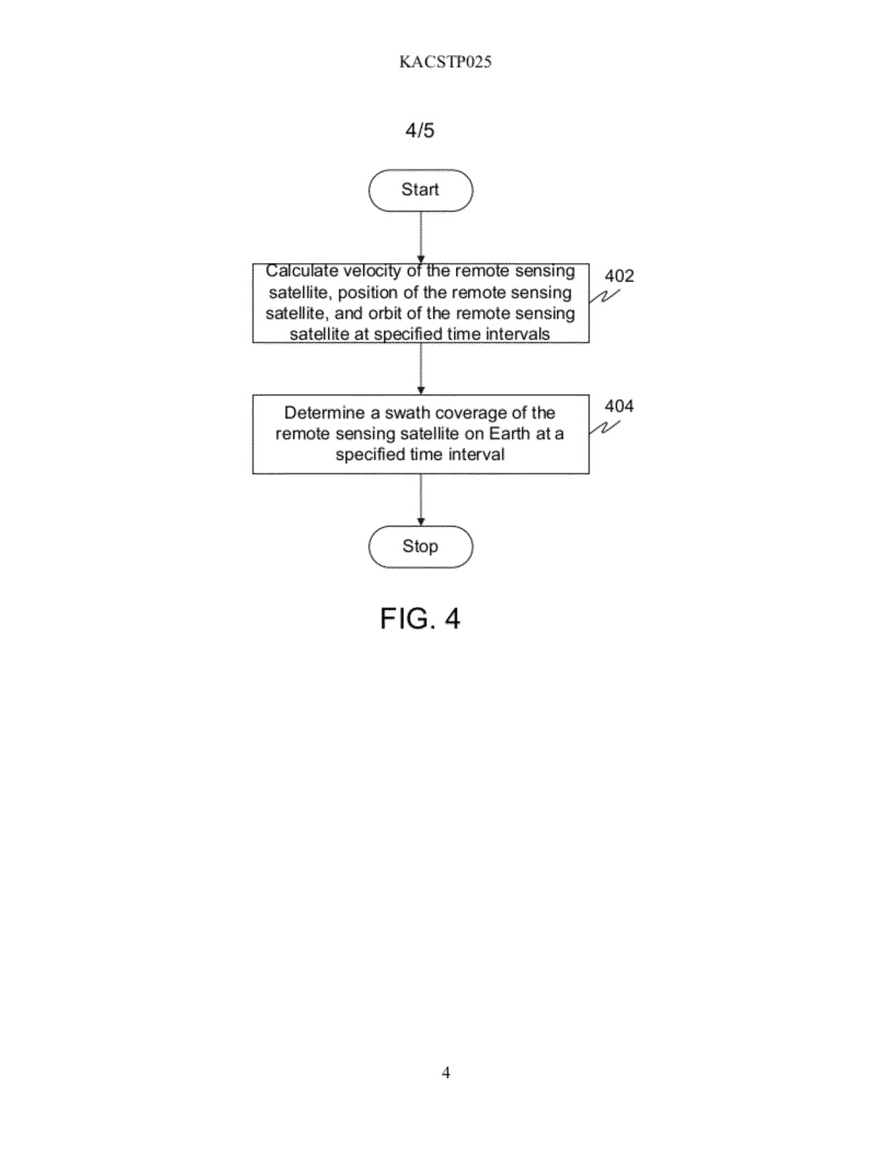

Thereafter, satellite tracker 210 performs one or more operations to determine the swath coverage of remote sensing satellite 202 at the specified time interval. Subsequently, satellite tracker 210 models the position of remote sensing satellite 202 at the specified time interval. For example, satellite tracker 210 may model the attitudinal, longitudinal, and latitudinal information of remote sensing satellite 202 at time t₀, and then at time t₁. This is further explained in conjunction with FIG. 4.

After modeling and determining the position and velocity vectors (as explained in conjunction with FIG. 2), satellite tracker 210 determines the swath coverage of remote sensing satellite 202 at the specified time interval (t₀ through t₁). The swath coverage is composed of four points on Earth in the form of four corners of a rectangle of which images can be captured by remote sensing satellite 202. It will be evident to a person skilled in the art that representation of the swath coverage is not restricted to a particular geometrical shape and any polygon may be used for representing the swath coverage of remote sensing satellite 202. Satellite tracker 210 may map the swath coverage with appropriate cartographic symbology. In an embodiment, satellite tracker 210 may save the swath coverage in a Geographic Information System (GIS) context.

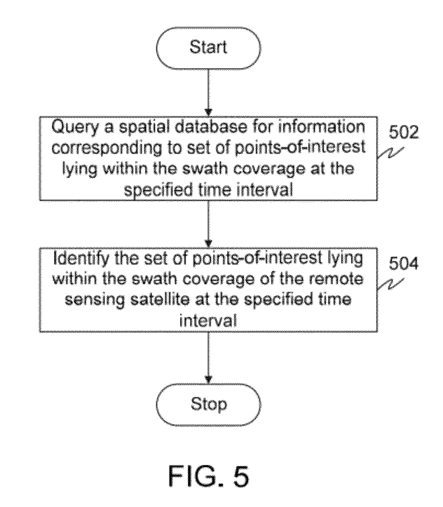

At step 304, mission planner 212 identifies a set of points-of-interest lying within the swath coverage of remote sensing satellite 202 at the specified time interval. In order to identify the set of points-of-interest, mission planner 212 queries spatial database 208. Spatial database 208 corresponds to a GIS system that includes information about real-world locations. The set of points-of-interest corresponds to the real-world locations stored in spatial database 208. Mission planner 212 may use coordinate information associated with the swath coverage of remote sensing satellite 202 on Earth for identifying the set of points-of-interest stored in spatial database 208. This is further explained in conjunction with FIG. 5.

Thereafter, at step 306, mission planner 212 associates a goodness factor to each point-of-interest of the set of points-of-interest. The goodness factor is associated based on a satellite mission requirement and it indicates a utility level of each point-of-interest with respect to the remote sensing satellite mission. The utility level describes the usefulness of the point-of-interest for the remote sensing satellite mission.

In order to associate the goodness factor, mission planner 212 performs one or more fitness calculation steps on the set of points-of-interest. The one or more fitness calculation steps process each point-of-interest of the set of points-of-interest to determine the utility level of each point-of-interest of the set of points-of-interest based on the satellite mission requirement. For example, the one or more fitness calculation steps may determine if a point-of-interest “A” is better than a point-of-interest “B” in context of the remote sensing satellite mission. This has already been explained in conjunction with FIG. 2. In an embodiment, the one or more fitness calculation steps may compute and assign a fitness value to each time fragment present in the specified time interval by calculating fitness of each point-of-interest lying within the time fragment. An average fitness value of each point-of-interest lying within the time fragment may be determined to calculate the fitness value of each time fragment.

The satellite mission requirements that are considered for the execution of the one or more fitness calculation steps for associating the goodness factor may correspond to one or more of a user defined criteria, and a user defined constraint. The user defined criteria may be modeled as a point-of-interest “type” and a “weightage” associated with the point-of-interest. The weightage associated with a point-of-interest type determines an importance of the point-of-interest. For example, a weight associated with a country type may be used for determining how important a country “A” is with respect to a country “B” in accordance with the user defined criteria. Thus, the weightage may be used for determining the importance a point-of-interest as compared to another point-of-interest. The user defined criteria may be used in a mathematical formula by the one or more fitness calculation steps for associating the goodness factor. The user defined constraint may correspond to a constraint that a human operator may consider during execution of the remote sensing satellite mission. This has already been explained in conjunction with FIG. 2.

After associating the goodness factor to each point-of-interest of the set of points-of-interest, mission planner 212 prioritizes each point-of-interest of the set of points-of-interest to obtain a sub-set of points-of-interest. The sub-set of points-of-interest corresponds to those points-of-interest for which one or more images may be captured successfully by remote sensing satellite 202. The sub-set of points-of-interest is selected based on a satellite resource constraint and the corresponding goodness factor associated with each point-of-interest using an artificial intelligence searching algorithm. The artificial intelligence searching algorithm may include one or more of a local search algorithm, and a greedy search algorithm. This has already been explained in conjunction with FIG. 2. The satellite resource constraint may include one or more of a weather constraint, a constraint associated with memory of the remote sensing satellite 202, and a constraint associated with power supply of remote sensing satellite 202.

The weather constraint includes constraint associated with weather status at the specified time interval over the swath coverage of remote sensing satellite 202, and radiometric status information over the swath coverage of remote sensing satellite 202 at the specified time interval. Information about the weather constraint may be retrieved from one or more weather stations located across the world. The one or more weather stations collect information about weather and provide the information to mission planner 212 for weather forecasting at the specified time interval. The information may include, but is not limited to, one or more of temperature, barometric pressure, humidity, wind speed, wind direction, and precipitation amounts.

Memory constraint associated with remote sensing satellite 202 includes information about available free memory present in remote sensing satellite 202. The constraint associated with the power supply of remote sensing satellite 202 includes information about remaining available power supply of remote sensing satellite 202. This has already been explained in conjunction with FIG. 2. Additionally, the artificial intelligence searching algorithm utilizes the goodness factor associated with each point-of-interest of the set of points-of-interest while selecting the sub-set of points-of-interest. Thus, the artificial intelligence searching algorithm gives more weightage to a point-of-interest having a high goodness factor when compared to points-of-interest having a low goodness factor.

After selecting the sub-set of points-of-interest from the set of points-of-interest, at step 310, mission planner 212 schedules remote sensing satellite 202 to capture one or more images for each point-of-interest of the sub-set of points-of-interest at the specified time interval. In order to schedule remote sensing satellite 202, mission planner 212 sends a scheduling command to remote sensing satellite 202 through transceiver 204. The scheduling command instructs remote sensing satellite 202 to capture the one or more images of each point-of-interest of the sub-set of points-of-interest when remote sensing satellite 202 is positioned above the swath coverage at the specified time interval. This has already been explained in conjunction with FIG. 2.

FIG. 4 illustrates a flowchart of a method for determining the swath coverage of remote sensing satellite 202 on Earth at the specified time interval in accordance with an embodiment of the invention. In order to determine the swath coverage of remote sensing satellite 202, orbit of remote sensing satellite 202 at the specified time interval needs to be calculated. Further, information regarding one or more pointable sensors located on remote sensing satellite 202 may also be considered while determining the swath coverage. At step 402, satellite tracker 210 calculates orbit of remote sensing satellite 202 using orbital elements of remote sensing satellite 202. This has already been explained in conjunction with FIG. 3. In order to calculate the orbit of remote sensing satellite 202, an orbital elements propagation algorithm may be utilized. A propagation algorithm may be used for producing the position and velocity vectors in ECI coordinate system. Thereafter, the ECI coordinates are converted into geodetic coordinates.

After converting the ECI coordinates into geodetic coordinates, at step 404, satellite tracker 210 may use one or more swath coverage determining algorithm for determining the swath coverage of remote sensing satellite 202 at the specified time interval. Once the swath coverage of remote sensing satellite 202 is determined, the points defining the swath coverage may be modeled in a form of a regular polygon by satellite tracker 210.

FIG. 5 illustrates a flowchart of a method for identifying the set of points-of-interest lying within the swath coverage of remote sensing satellite 202 at the specified time interval. After determining the swath coverage of remote sensing satellite 202, mission planner 212 may process the information associated with the swath coverage for querying spatial database 208. Mission planner 212 may extract the points of the regular polygon that define the swath coverage such that the points may be used as input for querying spatial database 208. The points may correspond to latitudinal, longitudinal, and attitudinal coordinates of the swath coverage. After extracting the points associated with the swath coverage of remote sensing satellite 202, at step 502, mission planner 212 queries spatial database 208 for the set of points-of-interest lying with the swath coverage using the points as input. The points may be converted to an OpenGIS standard before they are input to spatial database 208. This has already been explained in conjunction with FIG. 2.

Thereafter, at step 504, mission planner 212 identifies the set of points-of-interest lying within the swath coverage of remote sensing satellite 202 as a result of execution of the query in spatial database 208. In order to execute the query in spatial database 208 to identify the set of points-of-interest, mission planner 212 may also provide information regarding the remote sensing satellite mission along with the query. For example, if the remote sensing satellite mission associated with remote sensing satellite 202 corresponds to retrieving images and information associated with volcanoes on Earth, mission planner 212 executes a query in spatial database 208 for retrieving information about volcanoes in the swath coverage of remote sensing satellite 202 at the specified time interval. Accordingly, the information is retrieved if one or more volcanoes are present in the swath coverage.

Consider an exemplary embodiment of the invention as described herein, wherein a goal of a remote sensing satellite mission is to capture images and acquire information regarding volcanoes on Earth. Details of the remote sensing satellite mission are fed to a mission planner that is present at a ground station on the Earth. The mission planner generates a schedule for a remote sensing satellite to capture one or more images of the volcanoes. The mission planner is communicatively coupled to one or more transceivers present at the ground station. The information associated with the remote sensing satellite mission may be processed and converted into a standard format before being fed to the mission planner.

A satellite tracker is used for determining a swath coverage of the remote sensing satellite at a specified interval. The satellite tracker is adaptively coupled to the mission planner and is present at the ground station. In order to determine the swath coverage of the remote sensing satellite, the satellite tracker performs one or more mathematical operations on orbital elements associated with the remote sensing satellite to determine orbital state vectors of the remote sensing satellite in a coordinate system. The orbital state vectors are used by the satellite tracker to calculate position of the remote sensing satellite. After determining the orbital state vectors, the satellite tracker performs one or more operations to determine the swath coverage of the remote sensing satellite at the specified time interval.

Subsequently, the satellite tracker models the position of the remote sensing satellite at various points in time in the future using one or more orbital propagation algorithms. For example, the satellite tracker may model the position of the remote sensing satellite after two days from the current day. The position information of the remote sensing satellite may be represented in the form of attitudinal, longitudinal, and latitudinal coordinates. Once the swath coverage of the remote sensing satellite is determined, the points defining the swath coverage may be modeled in the form a regular polygon by the satellite tracker.

Thereafter, the mission planner utilizes the information associated with the swath coverage of the remote sensing satellite to run a query in a spatial database present at the ground station. The spatial database stores information about various points-of-interest on the Earth. The information about the various points-of-interest may be stored in spatial database by storing parameters such as “location” and “type” associated with each point-of-interest. For example, a point-of-interest may correspond to one or more of a type such as a point, a line, and a polygon. The points-of-interest may also be tagged with a time fragment that they belong to within the specified time interval. In an embodiment, spatial database 208 may be associated with an optimized index for improving the performance of spatial database 208. Thus, the spatial Database is optimized for storage and retrieval of the various points-of-interest.

The information associated with the swath coverage may be converted to a particular format before running the query in the spatial database. For example, the mission planner may process the information associated with the swath coverage of the remote sensing satellite and covert the information into an OpenGIS standard before running the query in the spatial database. An exemplary query as shown below may be used in accordance with OpenGIS standard format that may be utilized for querying the spatial database for information concerning one or more volcanoes that are present in the swath coverage of the remote sensing satellite.

SELECT (...) FROM database WHERE (type=volcano) AND St_contains (GeomFromText (‘POLYGON ((point 1, point 2, point 4, point 3, point 1))’, SRID), LOCATION

Execution of the query represented above provides a list of one or more volcanoes that lie within the swath coverage of the remote sensing satellite at specified time intervals in future. After identifying the one or more volcanoes that are present within the swath coverage of the remote sensing satellite, the mission planner associates a goodness factor to each volcano of the one or more volcanoes. The goodness factor is associated with each volcano of the one or more volcanoes based on one or more remote sensing satellite mission requirements. The goodness factor indicates a utility level associated with each volcano of the one or more volcanoes. In order to associate the goodness factor, the mission planner performs one or more fitness calculation steps. The one or more fitness calculation steps are performed based on the one or more remote sensing satellite mission requirements to determine the utility level of each volcano.

The one or more remote sensing satellite mission requirements correspond to one or more of a user defined criteria, and a user defined constraint. The user defined criteria for performing the one or more fitness calculation steps to associate the goodness factor may correspond to giving a higher weightage to volcanoes that are active in nature. Alternatively, the user defined criteria may correspond to volcanoes that are in the northern hemisphere of the Earth. It will be evident to a person skilled in the art that various other user defined criteria may be considered while associating the goodness factor to each volcano of the one or more volcanoes lying within the swath coverage of the remote sensing satellite. Similarly, the user defined constraint may correspond to constraints that the human operator may consider while selecting the one or more volcanoes. For example, active volcanoes may receive a higher goodness factor as compared to non-active volcanoes. The user defined constraint may be fed to the mission planner by a human operator or they may be automatically determined by the mission planner using various sources of information. In an embodiment, a system may be trained over a period of time by human operators for determining the user defined constraint. The training may be imparted through a machine learning algorithm that adaptively re-adjusts weights in mathematical formulas that are used for calculating the goodness factor.

After associating the goodness factor, the mission planner prioritizes each volcano of the one or more volcanoes to obtain a set of volcanoes from the one or more volcanoes. The set of volcanoes correspond to those volcanoes for which one or more images may be captured successfully by the remote sensing satellite. The set of volcanoes are selected based on a satellite resource constraint associated with the remote sensing satellite and the goodness factor associated with each volcano using an artificial intelligence searching algorithm. Examples of the artificial intelligence searching algorithm may include one or more of a local searching algorithm and a greedy searching algorithm. This has already been explained in conjunction with FIG. 3.

The satellite resource constraint may include one or more of a weather constraint, a constraint associated with memory of the remote sensing satellite, and a constraint associated with power supply of the remote sensing satellite. For example, if weather over a volcano is expected to deteriorate, the mission planner may give higher priority to another volcano, even though it may have a lower goodness factor associated with it. Similarly, if the remaining available free memory associated with the remote sensing satellite is low, the mission planner may select only a few of the one or more volcanoes for the remote sensing satellite. In the same manner, if remaining available power supply of the remote sensing satellite indicates that images for only an “n” number of volcanoes may be successfully captured, then the mission planner may select only “n” number of volcanoes.

After selecting the set of volcanoes from the one or more volcanoes, the mission planner schedules the remote sensing satellite to capture one or more images for each volcano of the set of volcanoes at the specified time interval. In order to schedule the remote sensing satellite, the mission planner sends a scheduling command to the remote sensing satellite through the one or more transceiver located at the ground station. The scheduling command instructs the remote sensing satellite to capture the one or more images of each volcano of the set of volcanoes when the remote sensing satellite is positioned above the swath coverage at the specified time interval. After capturing the one or more images, the remote sensing satellite sends the one or more images to the mission planner using one or more transceivers that are located on the remote sensing satellite. At this step, the remote sensing satellite mission is completed and the captured images may be shown in a graphical user interface. Thereafter, the human operator may view the results of the remote sensing satellite mission in order to evaluate the remote sensing satellite mission.

Those skilled in the art will appreciate that the method and system has been explained with respect a single remote sensing satellite for illustrative purpose only and to facilitate ease of understanding. In accordance with the method and system, a plurality of remote sensing satellites may be utilized for performing a remote sensing satellite mission. This is achieved by scheduling each remote sensing satellite of the plurality of remote sensing satellites based on their availability and a swath coverage at a specified time interval for performing the remote sensing satellite mission.

Various embodiments of the method and system described herein facilitate the automated selection of one or more points-of-interest in a swath coverage of a remote sensing satellite. The method and system provides a spatial database for selecting one or more points-of-interest taking into account satellite mission requirements and one or more constraints associated with the remote sensing satellite, geographical location and local laws. Further, the method and system automatically schedules the remote sensing satellite to capture one or more images of the points-of-interest.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method for automatically planning and scheduling a remote sensing satellite mission from a ground station at a specified time interval, the method comprising:
determining a swath coverage of the remote sensing satellite on Earth at the specified time interval;
identifying a set of points-of-interest lying within the swath coverage of the remote sensing satellite at the specified time interval;
associating a goodness factor to each point-of-interest of the set of points-of-interest based on a satellite mission requirement, wherein a goodness factor associated with a point-of-interest indicates utility level of the point-of-interest with respect to the remote sensing satellite mission;
selecting a sub-set of points-of-interest from the set of points-of-interest based on a satellite resource constraint and a corresponding goodness factor associated with each point-of-interest using an artificial intelligence searching algorithm; and
scheduling the remote sensing satellite to capture at least one image for each point-of-interest of the sub-set of points-of-interest.

2. The method of claim 1, wherein determining further comprises calculating velocity of the remote sensing satellite, position of the remote sensing satellite, and orbit of the remote sensing satellite at specified time intervals

3. The method of claim 1, wherein identifying comprises querying a spatial database using the swath coverage of the remote sensing satellite for information corresponding to the set of points-of-interest lying within the swath coverage at the specified time interval.

4. The method of claim 3, wherein the information corresponds to geographic information of the set of points-of-interest.

5. The method of claim 1, wherein the satellite mission requirement comprises at least one of a user defined criteria, and a user defined constraints.

6. The method of claim 1, wherein the satellite resource constraint comprises at least one of a weather constraint, a constraint associated with memory of the remote sensing satellite, and a constraint associated with power supply of the remote sensing satellite.

7. A system for automatically planning and scheduling a remote sensing satellite mission from a ground station at a specified time interval, the system comprising:
a satellite tracker for determining a swath coverage of the satellite at the specified time interval; and
a mission planner adaptively coupled to the satellite tracker, wherein the mission planner is configured to:
identify a set of points-of-interest lying within the swath coverage of the remote sensing satellite at the specified time interval;
associate a goodness factor to each point-of interest based on a satellite mission requirement, wherein a goodness factor associated with a point-of-interest indicates utility level of the point-of-interest with respect to the remote sensing satellite mission;
select a sub-set of points-of-interest from the set of points-of-interest based on a satellite resource constraint and a corresponding goodness factor associated with each point-of-interest using an artificial intelligence searching algorithm; and
schedule the remote sensing satellite to capture at least one image for each point-of-interest of the sub-set of points-of-interest.

8. The system of claim 7, wherein the satellite tracker is further configured to calculate velocity of the remote sensing satellite, position of the remote sensing satellite, and orbit of the remote sensing satellite.

9. The system of claim 7, wherein the mission planner is further configured to query a spatial database using the swath coverage of the remote sensing satellite for information corresponding to the set of points-of-interest lying within the swath coverage at the specified time interval.
